(19) United States
(12) Patent Application Publication
(10) Pub. No.: US 2021/0188283 A1
(43) Pub. Date: Jun. 24, 2021

(54) APPARATUS AND METHOD FOR ASCERTAINING INFORMATION VIA REFLECTION OF BOTH VISIBLE AND NON-VISIBLE WAVELENGTH LIGHT FROM A SURFACE

(71) Applicant: ZF FRIEDRICHSHAFEN AG, Friedrichshafen (DE)

(72) Inventors: ANTHONY LOUIS RIVAS, Royal Oak, MI (US); ROBERT J. NEWTON, Chesterfield, MI (US); MATHEW AUSTIN HUDSPETH, Warren, MI (US)

(21) Appl. No.: 16/720,843

(22) Filed: Dec. 19, 2019

(51) Int. Cl. B60W 40/06; G05D 1/00; G01N 21/3563; B60Q 1/00

(52) U.S. Cl. CPC B60W 40/06; G05D 1/0088; G01N 2021/3155; B60Q 1/0023; G05D 2201/0213; G01N 21/3563

(57) ABSTRACT

An apparatus for assisting with determination of a surface condition of a road adjacent a vehicle, via both visible and non-visible wavelength light, is described. A housing enclosure includes a light-permeable lens. A visible wavelength light source for directing visible light through the housing enclosure and out through the light-permeable lens onto a surface of the road is provided. An non-visible wavelength light source for directing non-visible light through the housing enclosure and out through the light-permeable lens onto a surface of the road is provided. A light receiver is provided for receiving a return light signal of at least one of visible and non-visible light reflected from the of the road and responsively producing a received-light signal. A method of at least partially detecting a surface condition of a road adjacent a vehicle is also provided.

### TECHNICAL FIELD

This disclosure relates to an apparatus and method for ascertaining information via reflection of both visible and non-visible wavelength light from a surface and, more particularly, to a method and apparatus for assisting with determination of a surface condition of a road adjacent a vehicle, using both visible and infrared light.

### BACKGROUND

Vehicle driver assist systems that use a camera to monitor the environment surrounding the vehicle are known. A driver assist system can aid a driver in the operation of a motor vehicle by providing operational information such as a potential collision, lane or roadway departure, location of pedestrians, road sign information, etc. Data from the driver assist system is provided to other vehicle systems to provide the driver with a warning, haptic or tactile feedback, and/or autonomous control of the vehicle.

A driver assist system in a vehicle may include a camera or other sensor, using visible or non-visible wavelength “light” sources, that acquires information and provides the acquired information to a vehicle safety system designed to assist the driver. The camera or other sensor may be mounted in, adjacent, or on any desired location in the vehicle, such as the vehicle bumper or other frontward area to ensure a desired field of view.

Vehicle manufacturers tend to limit size and position of vehicle components in order to maintain a standard look/feel for their vehicles. This places constraints around the placement and dimensions of cameras, sensors, light sources, or the like as used for driver assist systems. Moreover, high power requirement devices typically require more placement area, while the available locations in the vehicle for placement of such devices. are shrinking. Finally, there is incentive to conceal new devices within existing structures for at least aesthetic and space efficiency reasons.

Laser diode headlights are just beginning to be used in commercially available vehicles. An example of a prior art laser diode headlight 100 is shown in FIG. 1. In known laser diode headlights 100, visible light from laser diodes 102 are focused onto a luminescent material 104, which produces a light ten times brighter than the halogen bulbs found on most new, state-of-the-art vehicles. Optionally, and as shown in FIG. 1, a mirror 106 or other optical element(s) can be used to redirect or focus the laser diode 102 light output, or for any other purpose.

### SUMMARY

In an aspect, an ascertaining information via reflection of both visible and non-visible wavelength light from a surface is described. A housing enclosure includes a light-permeable lens. A visible wavelength light source for directing visible light through the housing enclosure and out through the light-permeable lens onto the surface provided. An non-visible wavelength light source for directing non-visible light through the housing enclosure and out through the light-permeable lens onto the surface is provided. A light receiver is provided for receiving a return light signal of at least one of visible and non-visible light reflected from the surface and responsively producing a received-light signal.

In an aspect, a method of at least partially detecting a surface condition of a road adjacent a vehicle, via both visible and non-visible wavelength light is described. An apparatus is provided, including a housing enclosure including a light-permeable lens; a visible wavelength light source, an non-visible wavelength light source, and a light receiver. With the visible wavelength light source, visible light is directed through the housing enclosure and out through the light-permeable lens onto a surface of the road. With the non-visible wavelength light source non-visible light is directed through the housing enclosure and out through the light-permeable lens onto a surface of the road. A return light signal at least one of visible and non-visible light reflected from the surface of the road is received with the light receiver and a received-light signal is responsively produced.

### BRIEF DESCRIPTION OF THE DRAWINGS

For a better understanding, reference may be made to the accompanying drawings, in which:

FIG. 1 is a schematic sectional side view of a prior art device;

FIG. 2 is a schematic sectional side view of an aspect of the present invention;

FIG. 3 is a schematic top view of the aspect of FIG. 2 in a first example use environment; and

FIG. 4 is a schematic top view of the aspect of FIG. 2 in a second example use environment.

### DESCRIPTION OF ASPECTS OF THE DISCLOSURE

Unless defined otherwise, all technical and scientific terms used herein have the same meaning as is commonly understood by one of skill in the art to which the present disclosure pertains.

As used herein, the singular forms “a,” “an” and “the” can include the plural forms as well, unless the context clearly indicates otherwise. It will be further understood that the terms “comprises” and/or “comprising,” as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

The invention comprises, consists of, or consists essentially of the following features, in any combination.

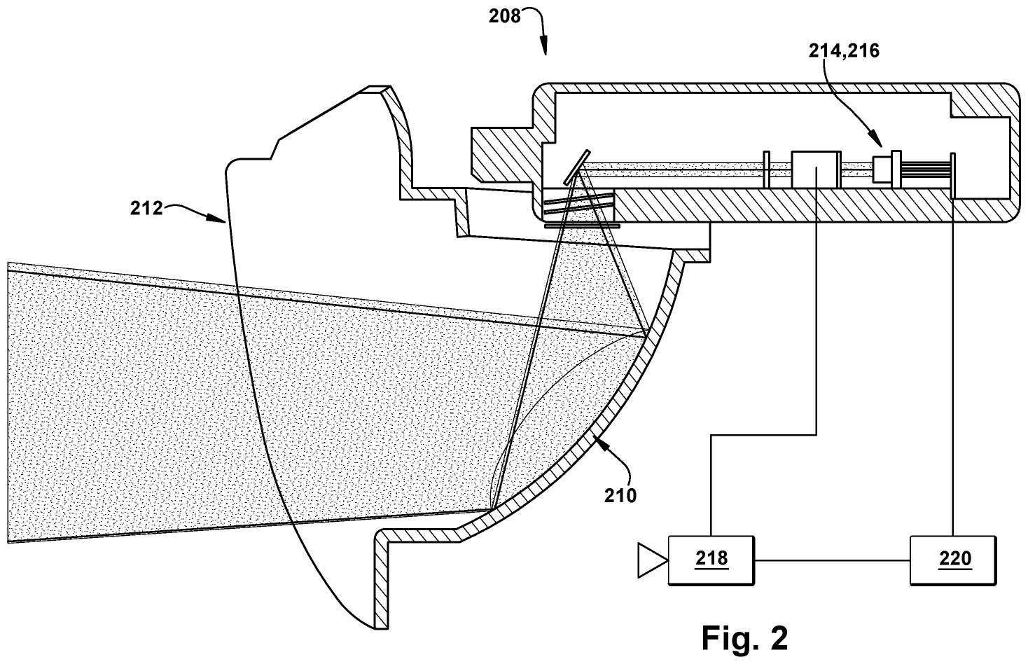

FIG. 2 depicts an apparatus 208 for providing both visible and non-visible wavelength light. The apparatus 208 is shown and described herein, for convenience, as being in an external light format (e.g., a headlight, taillight, running light, or any other component for providing illumination to an ambient space) for use with a vehicle. The apparatus 208 may, for example, assist with determination of a surface condition of a road adjacent a vehicle, via both visible and non-visible wavelength light in a system such as that shown and described in copending U.S. patent application Ser. No. 16/720,582, filed Dec. 19, 2019 and entitled METHOD OF CONTROLLING A VEHICLE AND DRIVER ASSIST SYSTEM (attorney docket no. DAS-028945 US PRI, hereafter referenced as “the road condition patent application”), the entire contents of which are incorporated herein by reference. However, it is contemplated that the apparatus 208 could be any apparatus which is configured for ascertaining information via reflection of both visible and non-visible wavelength light from a surface such as, but not limited to, security systems or medical imaging devices.

In the apparatus 208, a housing enclosure 210 includes a light-permeable lens 212. The housing enclosure 210 could be, for example, a vehicle headlight and/or taillight assembly, which will be used as an example use environment for the sake of the present description.

A visible wavelength light source 214 is provided for directing visible light through the housing enclosure 210 and out through the light-permeable lens 212 onto a surface of the road adjacent the vehicle upon which the apparatus 208 is installed. The visible wavelength light source 214 could be a laser and/or at least one light emitting diode.

An non-visible wavelength light source 216 is provided for directing non-visible light through the housing enclosure 210 and out through the light-permeable lens 212 onto a surface of the road adjacent the vehicle upon which the apparatus 208 is installed. The non-visible wavelength light source 216 could be a laser and/or at least one light-emitting diode. It is contemplated that, for many use environments of the apparatus, the non-visible wavelength of light will be in at least one of an ultraviolet and an infrared wavelength range, and will be shown and described herein as being of an infrared wavelength range.

One or both of the visible and non-visible wavelength light sources 214 and 216 could be a modulated electromagnetic source (e.g. via frequency, amplitude, pulse width, or any other desired modulation scheme). One or both of the visible and non-visible wavelength light sources 214 and 216 could also or instead be an unmodulated electromagnetic source (e.g. an electromagnetic source of a certain wavelength)

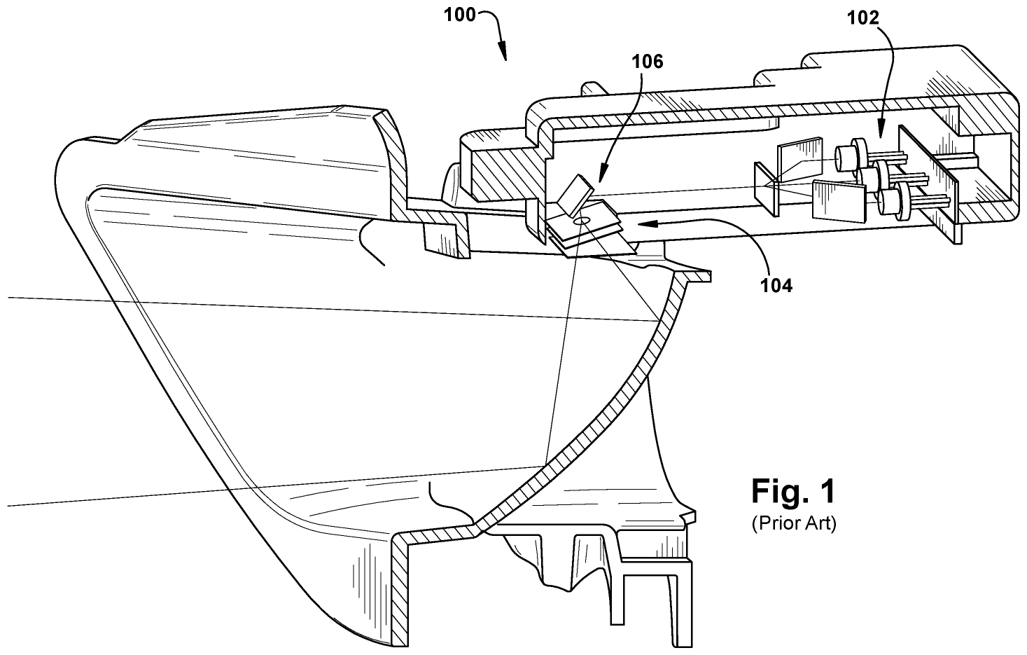

As shown and described herein, the apparatus 208 is a headlight or taillight assembly which can be installed upon a vehicle and used in much the same manner as existing laser diode headlights 100, such as that shown in FIG. 1. However, due to the presence of both the visible wavelength light source 214 and the non-visible wavelength light source 216 within the apparatus 208, the non-visible wavelength light can be provided to the road surface in much the same manner as the visible wavelength light is, but to provide enhanced utility for systems which provide different information to a vehicle operator than the information which can be ascertained using only visible wavelength light. Stated differently, the emission of the non-visible wavelength light is altered (before reflection) by material on the road in a way that conveys meaningful information to a system equipped to “read” such. By knowing what the return light signal “should” look like, the system can determine useful information about the road surface.

It is contemplated that the visible and non-visible wavelength light could be emitted by the apparatus 208 concurrently or consecutively, at different times during operation of the vehicle, and that either or both of the visible and non-visible wavelength light sources 214 and 216 could be controlled to provide any desired steady and/or patterned actuation, for any reason, as desired.

When non-visible wavelength light may be useful to a vehicle system, it can be very efficient for the non-visible wavelength light source 216 to be integrated into the same structure which provides power, housing, protection, and other attributes to a visible wavelength light source 214, such as a headlight function which already must be present on the vehicle to provide visible wavelength light to a driver. The non-visible wavelength light source 216 could be provided as part of a new, dual-wavelength apparatus 208, and/or could be integrated or retrofit into an existing laser diode headlight 100, depending upon the desires of a vehicle operator/designer. For example, a matrix of visible wavelength light emitting diodes and/or lasers used to create the headlight's visible beam to assist a driver in low-light conditions could have a selected portion of non-visible wavelength light emitting diodes and/or lasers within its matrix to act as the source for the signal. It could be very efficient (at least in terms of space usage and power consumption) to use a structure, such as an existing laser diode headlight 100, which is already designed to provide illuminating energy to a road surface in order to also produce and direct non-visible wavelength light onto the road surface. It is contemplated, however, that the visible wavelength light source 214 and non-visible wavelength light source 216 could be located in different areas of a single housing enclosure 210, or even in different housing enclosures 210, as desired for a particular use environment, without harm to the present invention.

A light receiver (shown schematically at 218) may be provided for receiving a return light signal of at least one of visible and non-visible light reflected from the surface of the road. The light receiver 218 could be located remotely from the apparatus 208 and/or could include components co-located with the housing enclosure to 10 or any other structure of the apparatus 208.

The light receiver 218 produces a received-light signal responsive to the receipt of the return light signal. A driver assist system including at least one of the light receiver 218 and the apparatus 208 may also include a controller (shown schematically at 220) for receiving the received-light signal and responsively producing a road surface evaluation signal. That is, the received-light signal represents electromagnetic interaction of the non-visible wavelength light with some remote device, material, substance, and/or any other condition. The received-light signal thus carries information indicative of the composition, distance, amount, location, and/or any other properties of that remotely observed condition.

The road surface evaluation signal, when present, may be provided to at least one of a user, a driver assist system, and an autonomous driving system. For example, the apparatus 100 could be used to determine whether a road surface in front of the vehicle is wet, snowy, or icy, in order to provide appropriate surface condition data to the system of the aforementioned road condition patent application.

It is contemplated that multiple predetermined wavelengths of non-visible light could be provided, sequentially and/or concurrently, at different times during vehicle operation in order to determine the condition of the road surface. For example, ice and water absorb infrared light at slightly different wavelengths (e.g., at or about substantially 1450 nm and 1550 nm, respectively), and therefore a controller 220 analyzing the return light signal can determine (e.g., via splitting or bracketing) whether ice, water, or both are present on the road surface ahead, and provide a road surface evaluation signal accordingly.

Because the non-visible wavelength light cannot be seen by the naked eye and thus will not result in glare or blinding complications for other (e.g., oncoming) drivers on the road, the non-visible wavelength light could be higher intensity, aimed slightly differently, and/or otherwise configured to interact with a greater area and/or further distance of the road surface than that which is illuminated by the visible wavelength light provided by the apparatus 208.

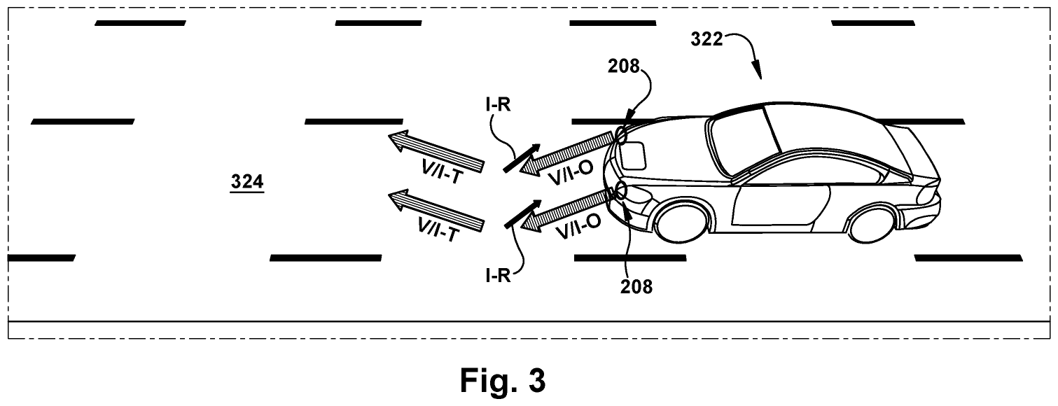

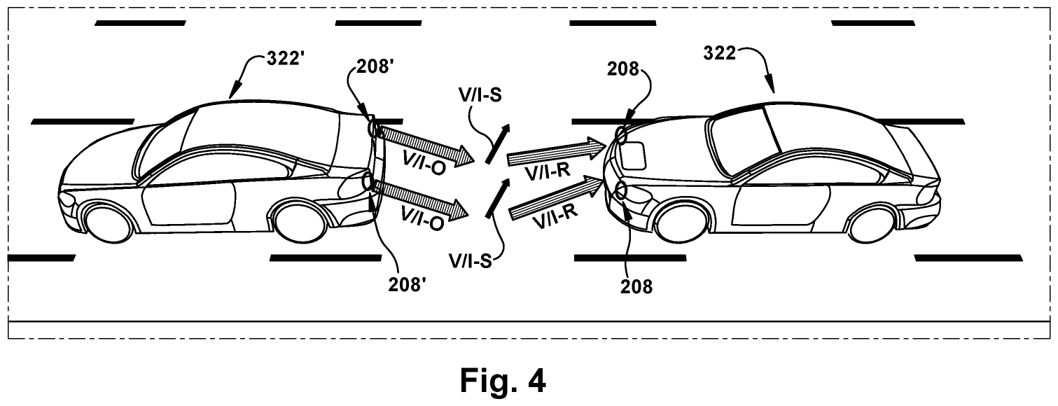

FIGS. 3-4 depict two example use configurations for the apparatus 208 on a vehicle 322. In FIG. 3, the apparatuses 208 are sending out both visible and non-visible light (arrows V/I-O) to the road surface 324. Because of the way the apparatuses are angled, only a relatively small portion of the non-visible light (the primary “reflected” light of concern for the sake of this description) is reflected back (arrows I-R). Instead, most of the visible and non-visible light (V/I-T) is transmitted further along the road surface 324. Because of the way the visible and non-visible wavelength light is reflected and transmitted along in front of the vehicle 322, relatively high-powered light output may be desired in some use environments/conditions in order to achieve desired “reflected” I-R light to provide a predetermined level of return light signal.

FIG. 4 depicts a second example use configuration, in which a second vehicle 322′ is equipped with apparatuses 208′ which send out both visible (e.g., taillight) and non-visible light. (In FIG. 4, for clarity of depiction, the arrows representing visible and non-visible light provided by the apparatuses 208 of the rearward vehicle 322 are omitted, but will additionally be present in most circumstances, as in the depiction of FIG. 3.) The apparatuses 208′ of the second, leading vehicle 322′ emit both visible and non-visible light (arrows V/I-O) to the road surface 324. Because of the way the apparatuses are angled, a relatively large portion of the visible and non-visible light is directed backward, and thus reflected off the road surface toward the following vehicle 322 (arrows V/I-R), with only a small portion of the visible and non-visible light (V/I-S) being scattered away from the following vehicle 322. In this way, when multiple vehicles 322 on the road include a system having the apparatus 208 shown and described herein, additional illumination in the desired wavelengths, having better directionality, can be provided through the use of one or apparatuses 208 emitting visible and/or non-visible wavelength light rearward, or in any other desired direction, from the vehicle. Thus, for example, a following vehicle 322 could achieve an improved signal-to-noise ratio through the addition of the non-visible light from the leading vehicle 322′ than if the following vehicle 322 itself is providing the only illumination. It is contemplated that the apparatuses 322, or other components, of multiple vehicles traveling in proximity on a road could communicate with each other in any desired manner (real-time and/or prearranged) to coordinate emission and/or detection of visible and/or non-visible light, in any desired manner.

A method of at least partially detecting a surface condition of a road adjacent a vehicle, via both visible and non-visible wavelength light can use an apparatus 208 similar to that shown in FIG. 2, which includes a housing enclosure 210 including a light permeable lens 212. A visible wavelength light source 214 and an non-visible wavelength light source 216 are provided within the housing enclosure 210 and configured to emit light outward from the housing enclosure 210 through the light permeable lens 212. At least one light receiver 218 is provided in any desired position with respect to the housing enclosure 210, such as, but not limited to, within the housing enclosure 210 and/or remotely from the housing enclosure 210.

With the visible wavelength light source 214, visible light is directed through the housing enclosure 210 and out through the light-permeable lens 212 onto a surface of the road. Concurrently or sequentially (or both at different times during operation of the vehicle), the non-visible wavelength light source 216 directs non-visible light, which could be at least one infrared wavelength in some use environments, through the housing enclosure 210 and out through the light-permeable lens 212 onto the surface of the road.

A return light signal of at least one of visible and non-visible light reflected from the surface of the road is received with the light receiver 218. The light receiver 218 responsively produces a received-light signal.

The received-light signal from the light receiver 218 is then received, such as by a controller 220 or any other desired assisting component, and a road surface evaluation signal is produced responsive to receipt of the received-light signal from the light receiver 218. The road surface evaluation signal can then be provided to at least one of a user, a driver assist system, and an autonomous driving system, and used as input data for any desired purpose, such as, but not limited to, determining whether the road surface includes moisture, snow, ice, debris, or any other addition or condition of potential relevance to operation of the vehicle.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

We claim:

1. An apparatus for ascertaining information via reflection of both visible and non-visible wavelength light from a surface, the apparatus comprising:
a housing enclosure including a light-permeable lens;
a visible wavelength light source for directing visible light through the housing enclosure and out through the light-permeable lens onto the surface;
an non-visible wavelength light source for directing non-visible light through the housing enclosure and out through the light-permeable lens onto the surface; and
a light receiver for receiving a return light signal of at least one of visible and non-visible light reflected from the surface and responsively producing a received-light signal.

2. The apparatus of claim 1, wherein the non-visible wavelength light is infrared.

3. The apparatus of claim 1, wherein the visible wavelength light source is a laser.

4. The apparatus of claim 1, wherein the visible wavelength light source is at least one light-emitting diode.

5. The apparatus of claim 1, wherein the non-visible wavelength light source is a laser.

6. The apparatus of claim 1, wherein the non-visible wavelength light source is at least one light-emitting diode.

7. The apparatus of claim 1, wherein the housing enclosure is a vehicle external light assembly.

8. The apparatus of claim 7, wherein the housing enclosure is a vehicle headlight assembly.

9. The apparatus of claim 1, wherein the visible wavelength light source is a modulated electromagnetic source.

10. The apparatus of claim 1, wherein the visible wavelength light source is an unmodulated electromagnetic source.

11. The apparatus of claim 1, wherein the non-visible wavelength light source is a modulated electromagnetic source.

12. The apparatus of claim 1, wherein the non-visible wavelength light source is an unmodulated electromagnetic source.

13. An apparatus for assisting with determination of a surface condition of a road adjacent a vehicle, via both visible and non-visible wavelength light, including the apparatus of claim 1.

14. A driver assist system including the apparatus of claim 13, including a controller for receiving the received-light signal and responsively producing a road surface evaluation signal;
wherein the road surface evaluation signal is provided to at least one of a user, a driver assist system, and an autonomous driving system.

15. A method of at least partially detecting a surface condition of a road adjacent a vehicle, via both visible and non-visible wavelength light, the method comprising:
providing an apparatus including a housing enclosure including a light-permeable lens; a visible wavelength light source, an non-visible wavelength light source, and a light receiver;
with the visible wavelength light source, directing visible light through the housing enclosure and out through the light-permeable lens onto a surface of the road;
with the non-visible wavelength light source, directing non-visible light through the housing enclosure and out through the light-permeable lens onto the surface of the road; and
receiving a return light signal of at least one of visible and non-visible light reflected from the surface of the road with the light receiver and responsively producing a received-light signal.

16. The method of claim 15, wherein the non-visible wavelength light is infrared.

17. The method of claim 15, wherein each of the visible wavelength light source and the non-visible wavelength light source is at least one of a laser and at least one light-emitting diode.

18. The method of claim 15, wherein directing visible light through the housing enclosure and out through the light-permeable lens onto a surface of the road includes modulating the visible wavelength light.

19. The method of claim 15, wherein directing non-visible light through the housing enclosure and out through the light-permeable lens onto a surface of the road includes modulating the non-visible wavelength light.

20. The method of claim 15, including
receiving the received-light signal and responsively producing a road surface evaluation signal; and
providing the road surface evaluation signal to at least one of a user, a driver assist system, and an autonomous driving system.
